(19) United States
(12) Patent Application Publication
(10) Pub. No.: US 2026/0296125 A1
(43) Pub. Date: Oct. 1, 2026

(54) SHOCK ABSORBER AND VEHICLE

(71) Applicant: SHANGHAI MANJIE AUTOMOTIVE PRECISION PARTS CO., LTD, Shanghai (CN)

(72) Inventors: Taiyun Jiang, Shanghai (CN); Jiaxi Jiang, Shanghai (CN)

(21) Appl. No.: 18/814,451

(22) PCT Filed: Jun. 24, 2024
(86) PCT No.: PCT/CN2024/100838

§ 371 Date: May 31, 2026

(30) Foreign Application Priority Data
Aug. 18, 2023 (CN) 202311041235.0

(51) Int. Cl. B60G 17/08; B60G 13/00; B60G 13/08

(52) U.S. Cl. CPC B60G 17/08; B60G 13/001; B60G 13/08; B60G 2202/24; B60G 2206/41

(57) ABSTRACT

A shock absorber and a vehicle are provided and relate to the technical field of vehicles. The shock absorber includes a first connecting seat, a compression regulating valve, a rebound regulating valve and an oil replenishing system. A first mounting cavity and a second mounting cavity are formed in the first connecting seat. The compression regulating valve is arranged on the first mounting cavity. The rebound regulating valve is arranged on the second mounting cavity. An end of the oil replenishing system is connected to the first connecting seat. A first connecting channel is formed between the rebound regulating valve and the compression regulating valve. A second connecting channel is formed between the oil replenishing system and the rebound regulating valve. A third connecting channel is formed between the oil replenishing system and the compression regulating valve.

### CROSS-REFERENCE TO RELATED APPLICATION

This patent application is a national stage application of International Patent Application No. PCT/CN2024/100838, filed on Jun. 24, 2024, which claims priority to Chinese Patent Application No. 202311041235.0, filed on Aug. 18, 2023, both of which are incorporated herein by reference in their entireties.

### TECHNICAL FIELD

The present disclosure relates to the field of vehicles, in particular to a shock absorber and a vehicle.

### BACKGROUND

With the improvement in people's living standards, vehicles have become an increasingly important part of daily life as a key mode of transportation. Among the critical components influencing vehicle performance is the gas shock absorber. The shock absorber is generally installed on the chassis of the vehicle. The bottom connecting seat of the shock absorber is installed on the axle toward the tire, and the top connecting seat is installed on the frame toward the front or rear of the vehicle. The conventional shock absorber includes a compression regulating valve and a rebound regulating valve. The rebound regulating valve is arranged on the bottom connecting seat, and the compression regulating valve is arranged on the top connecting seat. According to this installation way of the rebound regulating valve, when the rebound regulating valve needs to be corrected and regulated, tools or hands need to be reached into the narrow space of the axle position behind the wheel, so that the compression valve or the rebound valve is inconvenient to regulate.

### SUMMARY

In order to solve the technical problem that the compression regulating valve and the rebound regulating valve in the shock absorber are inconvenient to regulate, the purpose of the present disclosure mainly is to provide a shock absorber and a vehicle capable of increasing the regulating space to facilitate the regulation of the compression regulating valve and the rebound regulating valve.

In order to achieve the above purpose, embodiments use the following technical solution.

According to one aspect of the embodiments, a shock absorber is provided, including:

a first connecting seat including a first mounting cavity and a second mounting cavity;

a compression regulating valve arranged on the first mounting cavity;

a rebound regulating valve arranged on the second mounting cavity, where a first connecting channel is formed between the compression regulating valve and the rebound regulating valve; and

an oil replenishing system, where an end of the oil replenishing system is connected to the first connecting seat, a second connecting channel is formed between the oil replenishing system and the rebound regulating valve, a third connecting channel is formed between the oil replenishing system and the compression regulating valve, oil liquid circularly flowing among the oil replenishing system, the compression regulating valve and the rebound regulating valve through the first connecting channel, the second connecting channel and the third connecting channel.

According to an embodiment of the present disclosure, the shock absorber further includes a second connecting seat, and another end of the oil replenishing system is connected to the second connecting seat.

According to an embodiment of the present disclosure, the oil replenishing system includes:

an oil reservoir cylinder group, where the oil reservoir cylinder group includes a first cavity and a second cavity, the oil liquid is stored in the oil reservoir cylinder group;

an air cylinder system including a first air cylinder group and a second air cylinder group, where the first air cylinder group, the rebound regulating valve and the second cavity are in liquid communication through the second connecting channel, and the second air cylinder group, the compression regulating valve and the first cavity are in liquid communication through the third connecting channel.

According to an embodiment of the present disclosure, the oil reservoir casing group includes a first oil reservoir cylinder and a second oil reservoir cylinder, the second oil reservoir cylinder is sleeved inside the first oil reservoir cylinder, a first gap cavity and a first oil through channel are formed between the first oil reservoir cylinder and the second oil reservoir cylinder, an inner cavity of the second oil reservoir cylinder is formed by the first cavity and the second cavity, and the first gap cavity is in liquid communication with the second cavity through the first oil through channel;

the first air cylinder group is in liquid communication with the rebound regulating valve through a second oil through channel, the rebound regulating valve is in liquid communication with the first gap cavity through a third oil through channel, and the second connecting channel is formed by the second oil through channel, the third oil through channel, the first gap cavity and the first oil through channel;

a fourth oil through channel is formed between the first cavity and the compression regulating valve, a fifth oil through channel is formed between the compression regulating valve and the second air cylinder group, and the third connecting channel is formed by the fourth oil through channel and the fifth oil through channel.

According to an embodiment of the present disclosure, the first air cylinder group and the second air cylinder group are respectively arranged on both sides of the oil reservoir cylinder group.

According to an embodiment of the present disclosure, the first oil through channel includes oil through holes formed in a side wall of the second oil reservoir cylinder, and the second oil through channel, the third oil through channel, the fourth oil through channel and the fifth oil through channel are all formed in the first connecting seat.

According to an embodiment of the present disclosure, the oil replenishing system further includes a piston valve system and a piston rod, the piston valve system is assembled at an end of the piston rod, another end of the piston rod is assembled to the second connecting seat, the piston rod drives the piston valve system to push the oil liquid inside the second oil reservoir cylinder to circulate between the first cavity and the second cavity.

According to an embodiment of the present disclosure, the first air cylinder group and the second air cylinder group are both nitrogen cylinders, and a volume of a liquid storage cavity of the first air cylinder group is smaller than a volume of a liquid storage cavity of the second air cylinder group.

According to an embodiment of the present disclosure, the first mounting cavity, the second mounting cavity and the second air cylinder group are all arranged on a same side of the first connecting seat, and the first mounting cavity is arranged between the second mounting cavity and the second air cylinder group along a direction from the first connecting seat to the second connecting seat.

According to another aspect of the present disclosure, a vehicle is provided. The vehicle includes a frame and the shock absorber, and the frame is connected to the first connecting seat.

Through the above-mentioned technical solutions, the shock absorber and the vehicle have the following advantages and positive effects.

The shock absorber includes a first connecting seat, a compression regulating valve, a rebound regulating valve and an oil replenishing system. A first mounting cavity and a second mounting cavity are formed in the first connecting seat. The compression regulating valve is arranged on the first mounting cavity. The rebound regulating valve is arranged on the second mounting cavity. An end of the oil replenishing system is connected to the first connecting seat. A first connecting channel is formed between the rebound regulating valve and the compression regulating valve. A second connecting channel is formed between the oil replenishing system and the rebound regulating valve. A third connecting channel is formed between the oil replenishing system and the compression regulating valve. Oil liquid can circularly flow among the oil replenishing system, the compression regulating valve and the rebound regulating valve through the first connecting channel, the second connecting channel and the third connecting channel. And then, the rebound regulating valve and the compression regulating valve can be arranged on the same connecting seat, so that the space for regulation and correction is increased to facilitate the correction and regulation of the rebound regulating valve and the compression regulating valve. Moreover, oil liquid can be quickly replenished through the first connecting channel, the second connecting channel and the third connecting channel since the spacing distance between the rebound regulating valve and the compression regulating valve is small, so that the response speed of the entire shock absorber is increased, and the reliability of the whole performance of the shock absorber is improved.

### BRIEF DESCRIPTION OF THE DRAWINGS

The attached figures herein are incorporated in the specification as a part of the specification, showing embodiments that are in accordance with the present disclosure, and used together with the specification to explain a principle of the present disclosure.

To describe the technical solutions in the embodiments in this application or in the prior art more clearly, the following briefly describes the attached figures required for describing the embodiments or the prior art. Apparently, those skilled in the art may still derive other drawings from these attached figures without creative efforts.

FIG. 1 is an entire three-dimensional structural schematic diagram of a shock absorber according to embodiments of the present disclosure;

FIG. 2 is an internal cross-section structural schematic diagram of a shock absorber according to embodiments of the present disclosure;

FIG. 3 is a partially enlarged structural schematic diagram of an internal cross section of a shock absorber according to embodiments of the present disclosure;

FIG. 4 is a flow direction schematic diagram of a shock absorber according to embodiments of the present disclosure in the oil replenishing process in the compression process;

FIG. 5 is a flow schematic diagram of a shock absorber according to embodiments of the present disclosure in the oil replenishing process in the rebound recovery process;

FIG. 6 is a curve graph of rebound regulating force values (the upper semi-circle is a rebound force value curve) in the prior art; and

FIG. 7 is a curve graph of rebound regulating force values (the upper semi-circle is a rebound force value curve) in the present disclosure.

### REFERENCE SIGNS

10 first connecting seat; 11 first mounting cavity; 12 second mounting cavity; 13 second oil through channel; 14 third oil through channel; 15 fourth oil through channel; 16 fifth oil through channel;
20 second connecting seat;
30 oil reservoir cylinder group; 31 first oil reservoir cylinder; 32 second oil reservoir cylinder; 321 first cavity; 322 second cavity; 33 first gap cavity; 34 first oil through channel;
40 air cylinder system; 41 first air cylinder group; 42 second air cylinder group;
50 piston valve system; 51 through hole;
60 piston rod;
101 compression regulating valve; and 102 rebound regulating valve.

### DETAILED DESCRIPTION

To make the purpose, technical solutions, and advantages of the embodiments of the present disclosure clearer, the following clearly and completely describes the technical solutions in the embodiments of the present disclosure with reference to the attached figures in the embodiments of the present disclosure. Apparently, the described embodiments are some rather than all of the embodiments of the present disclosure. Based on the embodiments in the present disclosure, all other embodiments obtained by those skilled in the art under the premise of without contributing creative labor fall within the scope of the present disclosure.

With the improvement of the living quality of people, vehicles, as an important means of transportation, have played an increasingly important role in people's lives, and the gas shock absorber is an important device that affects the driving performance of vehicles. The shock absorber is generally installed on the chassis of the vehicle. The bottom connecting seat of the shock absorber is installed on the axle toward the tire, and the top connecting seat is installed on the frame toward the front or rear of the vehicle. The conventional shock absorber includes a compression regulating valve and a rebound regulating valve. The rebound regulating valve is arranged on the bottom connecting seat, and the compression regulating valve is arranged on the top connecting seat. According to this installation way of the rebound regulating valve, when the rebound regulating valve needs to be corrected and regulated, tools or hands need to be reached into the narrow space of the axle position behind the wheel, so that the compression valve or the rebound valve is inconvenient to regulate.

In order to solve the technical problem that the compression regulating valve and the rebound regulating valve in the shock absorber are inconvenient to regulate, the present disclosure mainly aims to provide a shock absorber and a vehicle capable of increasing the regulating space to facilitate the regulation of the compression regulating valve and the rebound regulating valve. The shock absorber includes a first connecting seat 10, a compression regulating valve, a rebound regulating valve and an oil replenishing system. A first mounting cavity 11 and a second mounting cavity 12 are formed in the first connecting seat 10. The compression regulating valve is arranged on the first mounting cavity 11. The rebound regulating valve is arranged on the second mounting cavity 12. An end of the oil replenishing system is connected to the first connecting seat 10. A first connecting channel is formed between the rebound regulating valve and the compression regulating valve. A second connecting channel is formed between the oil replenishing system and the rebound regulating valve. A third connecting channel is formed between the oil replenishing system and the compression regulating valve. Oil liquid can circularly flow among the oil replenishing system, the compression regulating valve and the rebound regulating valve through the first connecting channel, the second connecting channel and the third connecting channel.

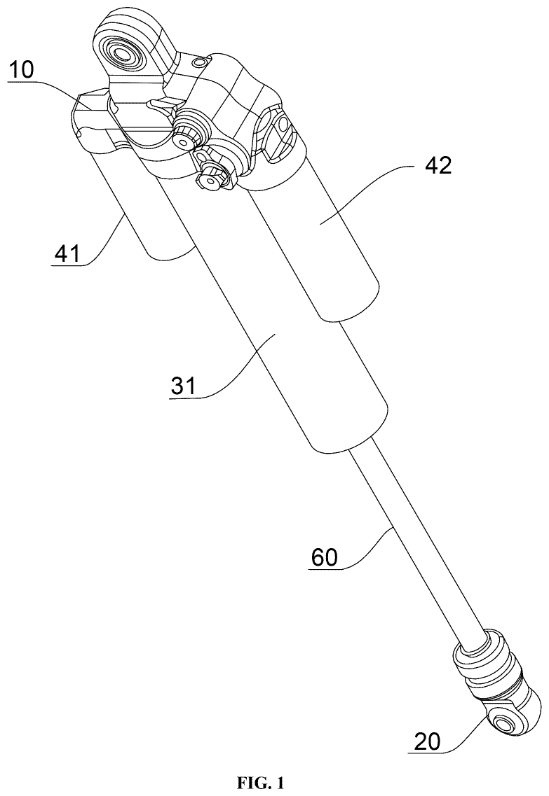

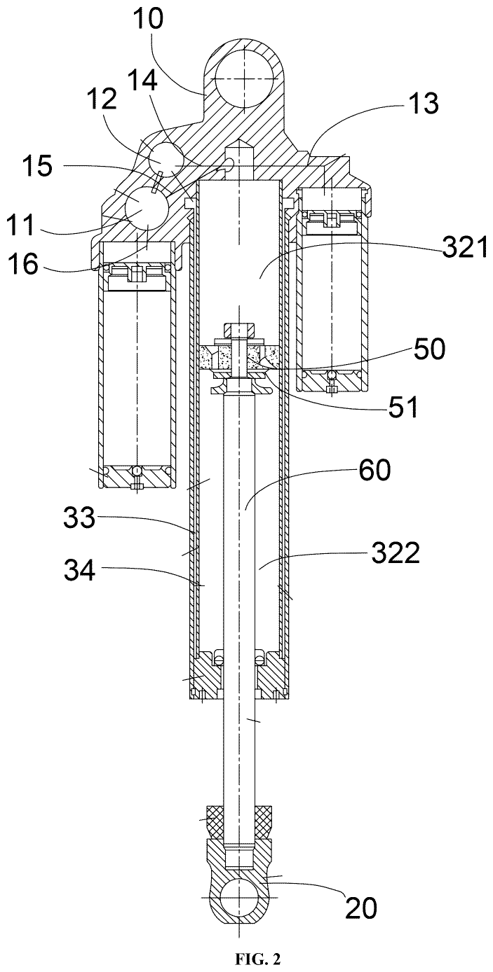

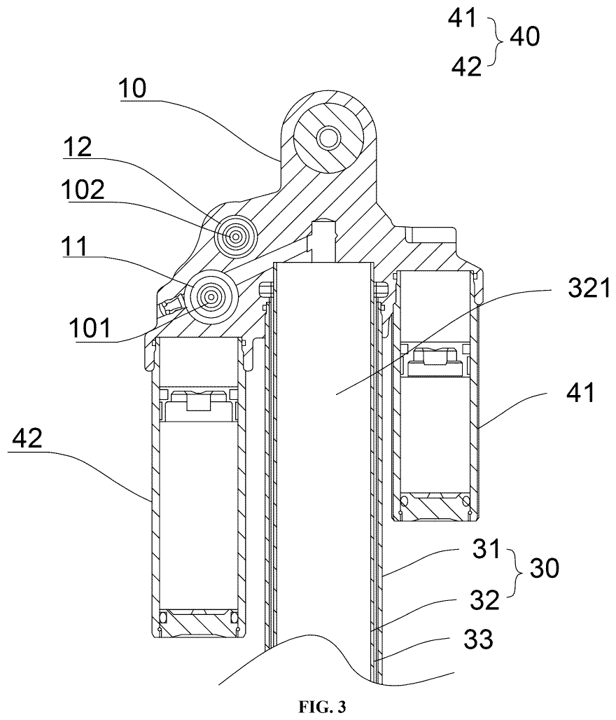

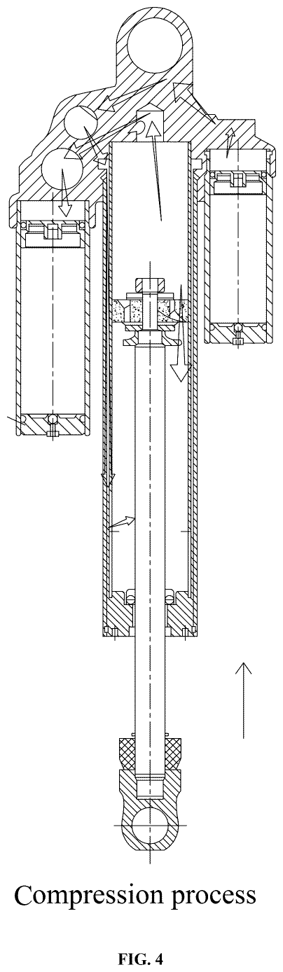

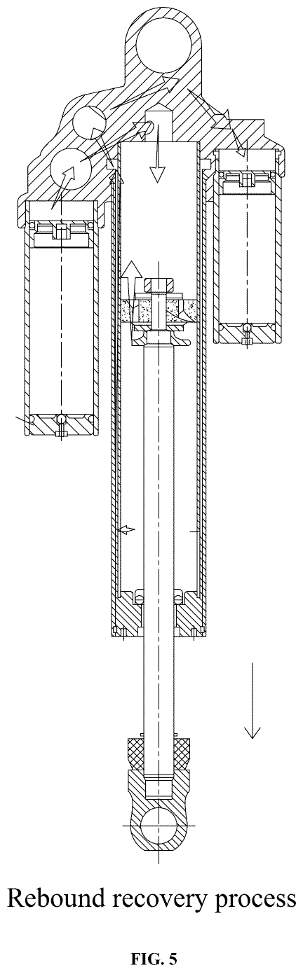

As shown in FIG. 1 to FIG. 5, the rebound regulating valve and the compression regulating valve can be arranged on the same connecting seat, so that the space for regulation and correction is increased to facilitate the correction and regulation of the rebound regulating valve and the compression regulating valve. Moreover, oil liquid can be quickly replenished through the first connecting channel, the second connecting channel and the third connecting channel since the spacing distance between the rebound regulating valve and the compression regulating valve is small, so that the response speed of the entire shock absorber is increased, and the reliability of the whole performance of the shock absorber is improved.

As an example, in actual use, the first connecting seat 10 can be used as a top connecting seat, and the first connecting seat 10 can be installed toward the frame at the front or rear of the vehicle. When a user needs to regulate the compression regulating valve and the rebound regulating valve, the operation space is larger, and the shock absorber is convenient to maintain.

According to an embodiment of the present disclosure, the shock absorber also includes a second connecting seat 20. Another end of the oil replenishing system is connected to the second connecting seat 20. The first connecting seat 10 and the second connecting seat 20 respectively face both ends of the oil replenishing system. The end of the oil replenishing system is connected to the first connecting seat 10, and the other end of the oil replenishing system is connected to the second connecting seat 20. The second connecting seat 20 can be arranged as the bottom connecting seat of the shock absorber, and the second connecting seat 20 is installed on the axle toward the wheel. The shock absorber is installed at a reasonable position through the first connecting seat 10 and the second connecting seat 20, so that the stability of the shock absorber is further improved during installation.

In another aspect, the oil replenishing system has a certain extended length. The oil replenishing system includes a piston assembly. The length between the first connecting seat 10 and the second connecting seat 20 meets the use requirements of the piston assembly. The piston assembly is configured for providing driving force to oil liquid so that the oil liquid circularly flows in the first connecting channel, the second connecting channel, and the third connecting channel.

Further, an end of the piston assembly can be connected to the first connecting seat 10, and another end of the piston assembly can be connected to the second connecting seat 20. The piston assembly enables the oil liquid to circulate in the connecting channels among the oil replenishing system, the compression regulating valve and the rebound regulating valve through piston movement.

In one compression recovery process, the oil liquid is switched with the piston movement of the piston assembly between the first connecting seat 10 and the second connecting seat 20. In this embodiment, the movement of the piston assembly toward the first connecting seat 10 is a compression process, and the movement of the piston assembly toward the second connecting seat 20 is a rebound recovery process. With the piston movement of the piston assembly between the first connecting seat 10 and the second connecting seat 20, the shock absorber is switched between the compression process and the rebound recovery process to achieve the purpose of shock absorption.

As an example, during the compression process, the piston assembly squeezes the oil liquid along a direction from the second connecting seat 20 to the first connecting seat 10. A part of the oil liquid is squeezed into the compression regulating valve through the third connecting channel, and the oil liquid is circulated to the oil replenishing system for storage after the regulation of the compression regulating valve, and the other part of the oil liquid is used for compensation to the piston assembly. The piston assembly drives the oil liquid toward the first connecting seat 10, and the oil liquid originally stored inside the oil replenishing system flows back into the rebound regulating valve through the second connecting channel. After the regulation of the rebound regulating valve, the oil liquid continues to be compensated to the piston assembly.

During the rebound recovery process, the piston assembly moves toward the position of the second connecting seat 20 and squeezes a part of the oil liquid to flow to the rebound regulating valve through the second connecting channel. After the oil liquid is regulated by the rebound regulating valve, the regulated oil liquid is returned into the oil replenishing system for storage. The other part of the oil liquid compensates the piston assembly. The oil liquid stored in the oil replenishing system after the compression process is returned into the piston assembly through the third connecting channel to participate in the compression process of the next cycle.

According to an embodiment of the present disclosure, the oil replenishing system includes an oil reservoir cylinder group 30 and an air cylinder system 40, the oil reservoir cylinder group 30 includes a first cavity 321 and a second cavity 322, and the oil liquid is stored in the oil reservoir cylinder group 30. The air cylinder system 40 includes a first air cylinder group 41 and a second air cylinder group 42, the first air cylinder group 41, the rebound regulating valve and the second cavity 322 are in liquid communication through the second connecting channel, and the second air cylinder group 42, the compression regulating valve and the first cavity 321 are in liquid communication through the third connecting channel.

The piston assembly can drive the oil liquid to pass through the oil reservoir cylinder group 30 and the air cylinder system 40 after the regulation of the compression regulating valve and the rebound regulating valve. The first air cylinder group 41 in the air cylinder system 40 is used as a liquid storage component of the oil replenishing system in the rebound process, and the second air cylinder group 42 is used as a liquid storage component of the oil replenishing system in the compression process. The two air cylinder groups are used for storing oil in the rebound recovery process and the compression process respectively, so that the oil replenishing efficiency is improved. The first cavity 321 of the oil reservoir cylinder group 30 is used as an oil storage area where the oil liquid is replenished to the piston assembly after the regulation of the compression regulating valve in the compression process, and the second cavity 322 of the oil reservoir cylinder group 30 is used as an oil storage area where the oil liquid is replenished to the piston assembly after the regulation of the compression regulating valve in the rebound recovery process. With the piston movement of the piston assembly, when vibration occurs between the first connecting seat 10 and the second connecting seat 20 due to the vibration between the frame and the axle, the shock absorber is switched in the compression process and the rebound recovery process, and shock absorption is performed on the vehicle.

Further, the first air cylinder group 41 and the second air cylinder group 42 are both arranged to be nitrogen cylinders.

Further, oil through holes can be formed in the piston assembly. The first cavity 321 is in communication with the second cavity 322 through the oil through holes, and then the piston assembly is used for replenishing oil for the second cavity 322 in the compression process, or replenishing oil for the first cavity 321 in the rebound recovery process so as to compensate the piston assembly. The oil replenishing efficiency of the entire shock absorber is improved, so that the response efficiency of the shock absorber is improved.

According to an embodiment of the present disclosure, the oil reservoir cylinder group 30 includes a first oil reservoir cylinder 31 and a second oil reservoir cylinder 32. The second oil reservoir cylinder 32 is sleeved inside the first oil reservoir cylinder 31. A first gap cavity 33 and a first oil through channel 34 are formed between the first oil reservoir cylinder 31 and the second oil reservoir cylinder 32. An inner cavity of the second oil reservoir cylinder 32 is formed by the first cavity 321 and the second cavity 322. The first gap chamber 33 is in fluid communication with the second cavity 322 through the first oil through channel 34. The piston assembly can be arranged inside the second oil reservoir cylinder 32, and the piston assembly performs piston movement inside the second oil reservoir cylinder 32. The inner cavity of the second oil reservoir cylinder 32 can be divided into the first cavity 321 and the second cavity 322 through the piston assembly, the first cavity 321 faces to the first connecting seat 10, and the second cavity 322 faces to the second connecting seat 20. The inner diameter of the first oil reservoir cylinder 31 is larger than that of the second oil reservoir cylinder 32, and then the first gap cavity 33 is formed between the first oil reservoir cylinder 31 and the second oil reservoir cylinder 32. The first oil reservoir cylinder 31 can be in communication with the second oil reservoir cylinder 32 through the first oil through channel 34. As an example, the first oil through channel 34 includes two oil through holes, and the two oil through holes are formed in the second oil reservoir cylinder 32. The inner cavity of the first oil reservoir cylinder 31 is in communication with the inner cavity of the second oil reservoir cylinder 32 through the two oil through holes to construct an oil replenishing circulating channel.

The first air cylinder group 41 is in liquid communication with the rebound regulating valve through a second oil through channel 13, the rebound regulating valve is in liquid communication with the first gap cavity 33 through a third oil through channel 14, and the second connecting channel is formed by the second oil through channel 13, the third oil through channel 14, the first gap cavity 33 and the first oil through channel 34. A fourth oil through channel 15 is formed between the first cavity 321 and the compression regulating valve, a fifth oil through channel 16 is formed between the compression regulating valve and the second air cylinder group 42, and a third connecting channel is formed by the fourth oil through channel 15 and the fifth oil through channel 16.

The second oil through channel 13, the third oil through channel 14, the fourth oil through channel 15 and the fifth oil through channel 16 can all be oil through holes formed in the first connecting seat 10 to enable oil to pass through the channels. Since the first connecting seat 10 faces to the frame, the inner diameters of the second oil through channel 13, the third oil through channel 14, the fourth oil through channel 15 and the fifth oil through channel 16 can be conveniently increased, and then the inner diameter of the entire oil replenishing flow channel is increased.

The rebound regulating valve is provided with two valve ports. One valve port is connected with the second oil through channel 13, and the other valve port is connected with the third oil through channel 14. The compression regulating valve is also provided with at least two valve ports. One valve port is in communication with the fourth oil through channel 15, and the other valve port is in communication with the fifth oil through channel 16. The overall oil through area is further increased and the idle stroke is reduced by adjusting the oil through area of the rebound regulating valve and the compression regulating valve.

For example, the oil through area of a single oil through hole in oil through holes of valve elements of the rebound regulating valve and/or the compression regulating valve can be set to 10.78 mm², so that the maximum overall oil through area of the rebound regulating valve or compression regulating valve can reach 43.152 mm².

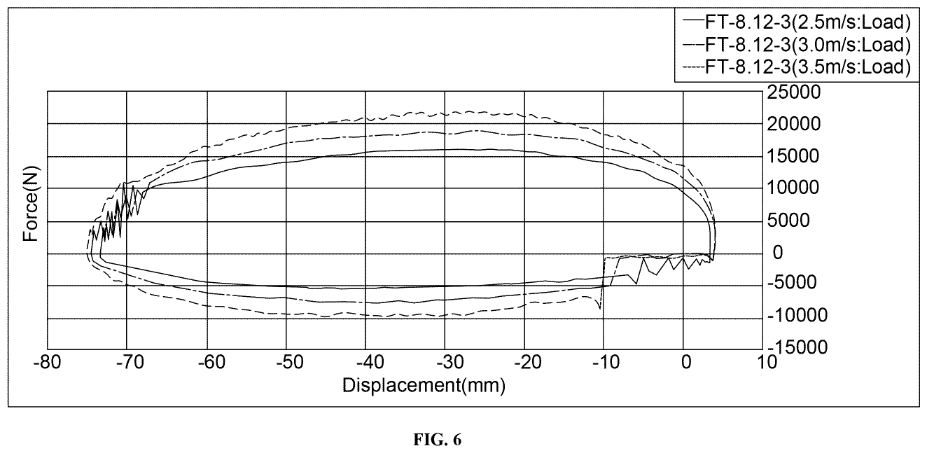

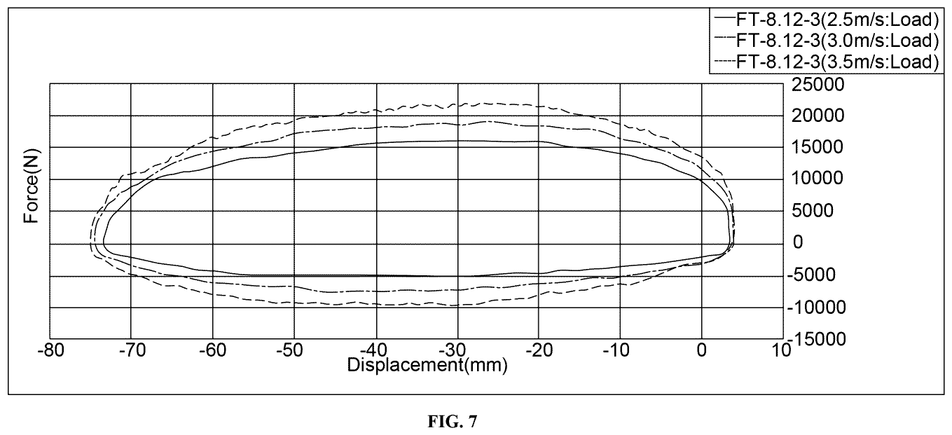

In conclusion, as shown in FIG. 6 and FIG. 7, in the curve graphs, the vertical axis refers to force values with the unit of N, where N is a rebound force value when being a positive value, and N is a compression force value when being a negative value. The horizontal axis refers to displacements with the unit of mm. From the curve graphs of FIG. 6 and FIG. 7, it is apparently found that compared with the prior art, the force value curve in the rebound recovery process in the present disclosure is smoother and fuller than the curve in the prior art, and the idle stroke is apparently reduced.

Therefore, after the structure with double oil reservoir cylinders and double nitrogen cylinders is used, oil is replenished in the compression process and the rebound process respectively, so that oil is replenished more quickly, and the response of the shock absorber is quicker. The force value test curve graph of the shock absorber is fuller, and the shock absorber is unlikely to generate idle stroke during high-speed operation.

In addition, the rebound regulating valve is integrated to the upper conjoined seat, compared with the prior art, the oil through area can be more flexibly increased on the basis of ensuring the convenience of regulation, so that the rebound recovery regulation has a larger regulation range, and the degree of adaptability to complex and harsh road conditions is higher, thereby further improving the overall performance of the shock absorber.

According to an embodiment of the present disclosure, the first air cylinder group 41 and the second air cylinder group 42 are respectively arranged on both sides of the oil reservoir cylinder group 30 to reasonably plan the installation space. Further, the volume of the second air cylinder group 42 can be larger than that of the first air cylinder group 41, so that the assembly position can be regulated more flexibly.

According to an embodiment of the present disclosure, the first oil through channel 34 includes oil through holes formed in a side wall of the second oil reservoir cylinder 32. The oil through holes can face to the first cavity 321, thereby achieving liquid communication between oil through holes and the first cavity 321.

According to an embodiment of the present disclosure, the oil replenishing system also includes a piston valve system 50 and a piston rod 60. The piston valve system 50 is assembled at an end of the piston rod 60, and the other end of the piston rod 60 is assembled to the second connecting seat 20. The piston rod 60 drives the piston valve system 50 to push the oil liquid inside the second oil reservoir cylinder 32 to circulate between the first cavity 321 and the second cavity 322. The piston valve system 50 is used for performing piston movement between the first cavity 321 and the second cavity 322, and a through hole 51 is formed in the piston valve system 50. The first cavity 321 and the second cavity 322 are in communication through the through hole 51, so that the efficiency of the oil replenishment cycle is further improved through the through hole 51.

According to an embodiment of the present disclosure, the first mounting cavity 11, the second mounting cavity 12 and the second air cylinder group 42 are all arranged on the same side of the first connecting seat 10, and the first mounting cavity 11 is arranged between the second mounting cavity 12 and the second air cylinder group 42 along the direction from the first connecting seat 10 to the second connecting seat 20. For example, the first mounting cavity 11 and the second mounting cavity 12 can be arranged on the first side of the first connecting seat 10, the second air cylinder group 42 is in threaded connection with the first connecting seat 10 on the first side, so that, a stabler installation position can be provided for the second air cylinder group 42 with a larger volume. The first air cylinder group 41 with a smaller volume is in threaded connection with the second side of the first connecting seat 10, so that, the occupation volume of the second side of the first connecting seat 10 is reduced, and more different use conditions are adapted.

In an embodiment, the shock absorber includes an upper conjoined seat (equivalent to the first connecting seat 10), an inner oil reservoir cylinder (equivalent to the second oil reservoir cylinder 32), an outer oil reservoir cylinder (equivalent to the first oil reservoir cylinder 31), a large nitrogen cylinder (equivalent to the second air cylinder group 42), a large floating piston and a large valve cap arranged inside the large nitrogen cylinder, a small nitrogen cylinder (equivalent to the first cylinder group 41), and a small floating piston and a small valve cap arranged inside the small nitrogen cylinder; a piston rod, a piston valve system 50, a lower connecting seat (equivalent to the second connecting seat 20), a buffer block, a compression regulating valve, a rebound regulating valve, and a seal assembly. The seal assembly is used for sealing the bottom of the inner oil reservoir cylinder and the outer oil reservoir cylinder, and the piston rod is sealed with the inner oil reservoir cylinder and the outer oil reservoir cylinder through the seal assembly.

The outer oil reservoir cylinder is connected with the upper conjoined seat and the seal assembly through threads, and the inner oil reservoir cylinder is connected with the upper conjoined seat and the seal assembly through step limit. The top of the piston rod passes through the seal assembly and is connected to the piston valve system 50 inside the shock absorber. The bottom of the piston rod is connected to the lower conjoined seat. The buffer block is arranged on the piston rod and is located outside the shock absorber. The piston rod can slide freely. The large and small nitrogen cylinders are connected with the upper conjoined seat through threads. The large and small floating pistons are respectively arranged inside the nitrogen cylinders. The large and small valve caps are respectively arranged at the tails of the nitrogen cylinders, which are limited by clamping rings. The compression regulating valve and the rebound regulating valve are connected with the upper conjoined seat through threads.

Six oil through holes are formed in the bottom of the inner oil reservoir cylinder, so that the inner cavity of the inner oil reservoir cylinder is in communication with the first gap cavity (outer cavity) between the inner oil reservoir cylinder and the outer oil reservoir cylinder. First oil through holes (equivalent to the fourth oil through channel 15) are formed between the first cavity (upper part) of the inner oil reservoir cylinder and the tail of the compression regulating valve. Second oil through holes (equivalent to the fifth oil through channel 16) are formed between the large nitrogen cylinder and the middle part of the compression regulating valve. Third oil through holes 3 (equivalent to the third oil through channel 14) are formed between the first gap cavity and the tail of the rebound regulating valve. Forth oil through holes 4 (equivalent to the second oil through channel 13) are formed between the small nitrogen cylinder and the middle part of the rebound regulating valve. Oil through holes (equivalent to the first connecting channel) are formed between the middle parts of the compression regulating valve and the rebound regulating valve for communication.

Above all, the operating principle of the shock absorber in the present disclosure is as follows.

When the shock absorber is in the compression operating state, the piston valve system 50 and the piston rod move in the direction of the upper conjoined seat. At this time, the piston pushes the oil liquid to enter into the compression regulating valve through the first oil through holes from the inner cavity. After regulation of the oil through holes of the compression regulating valve, the oil liquid enters into the large nitrogen cylinder through the second oil through hole. At the same time, a part of oil liquid is compensated to the space between the compression piston valve system 50 and the seal assembly through a compression oil hole of the piston valve system 50. The oil liquid inside the small nitrogen cylinder passes through the fourth oil through holes and enters into the outer cavity through the third oil through holes after passing through the one-way oil through hole of the rebound regulating valve. The oil liquid inside the outer cavity passes through small holes in the bottom of the inner cylinder to replenish the space between the piston valve system 50 and the seal assembly.

When the shock absorber is in the recovery operating state, the piston valve system 50 and the piston rod move in the direction of the lower connecting seat. At this time, the piston pushes the oil liquid from the second cavity 322 (lower) to enter into the first gap cavity 33 through the small holes in the bottom of the inner cylinder. The oil liquid in the first gap cavity 33 passes through the third oil through hole to enter into the rebound regulating valve. The oil liquid enters the small nitrogen cylinder through the fourth oil through holes after regulation of the oil through holes of the rebound regulating valve. At the same time, a part of oil liquid is compensated to the space between the compression piston valve system 50 and the upper conjoined seat through a rebound oil hole of the piston valve system 50. The oil liquid inside the large nitrogen cylinder passes through the second oil through holes and enters into the first cavity 321 (upper) through the first oil through holes after passing through the one-way oil through hole of the compression regulating valve to replenish the space between the piston valve system 50 and the upper conjoined seat.

According to another aspect of the present disclosure, a vehicle is provided. The vehicle includes a frame and the shock absorber described above, and the frame is connected with the first connecting seat 10. The first connecting seat 10 is used as a connecting seat on the top. The compression regulating valve and the rebound regulating valve are both arranged on the first connecting seat 10, so that a larger operation space is provided for later maintenance, and the compression regulating valve and/or the rebound regulating valve can be regulated conveniently in the later stage. Because the installation space of the rebound regulating valve is larger, the special regulating valve with a larger oil through area can be conveniently selected, and the oil replenishment efficiency is further improved. By means of the structure with double oil reservoir cylinders and double nitrogen cylinders, the response of the shock absorber is quicker, the force value test curve of the shock absorber is fuller, and the shock absorber is unlikely to generate idle stroke during the high-speed operation process, and then the shock absorption effect in the driving process of the vehicle is improved.

It needs to be noted that in this specification, relational terms such as “first” and “second” are only used to distinguish one entity or operation from another, and do not necessarily require or imply that any actual relationship or sequence exists between these entities or operations. Moreover, the terms “comprise”, “include”, or their any other variants are intended to cover a non-exclusive inclusion, so that a process, a method, an article, or a device that includes a list of elements not only includes those elements but also includes other elements that are not expressly listed, or further includes elements inherent to such a process, method, article, or device. In absence of more constraints, an element defined by “includes a” does not preclude the existence of other identical elements in the process, method, article, or device that includes the element.

The above relates to an embodiment of the present disclosure, so that those skilled in the art can understand or realize the present disclosure. Various modifications to the embodiments are apparent to those skilled in the art, and general principles defined in the present disclosure may be implemented in other embodiments without departing from the spirit or scope of the present disclosure. Therefore, the present disclosure will not be limited to the embodiments described in the present disclosure but extends to the widest scope that complies with the principles and novelty disclosed in the present disclosure.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

What is claimed is:

1. A shock absorber, comprising:
a first connecting seat (10) comprising a first mounting cavity (11) and a second mounting cavity (12);
a compression regulating valve arranged on the first mounting cavity (11);
a rebound regulating valve arranged on the second mounting cavity (12), wherein a first connecting channel is formed between the compression regulating valve and the rebound regulating valve; and
an oil replenishing system, wherein an end of the oil replenishing system is connected to the first connecting seat (10), a second connecting channel is formed between the oil replenishing system and the rebound regulating valve, a third connecting channel is formed between the oil replenishing system and the compression regulating valve, oil liquid circularly flowing among the oil replenishing system, the compression regulating valve and the rebound regulating valve through the first connecting channel, the second connecting channel and the third connecting channel.

2. The shock absorber according to claim 1, wherein the shock absorber further comprises a second connecting seat (20), and another end of the oil replenishing system is connected to the second connecting seat (20).

3. The shock absorber according to claim 2, wherein the oil replenishing system comprises:
an oil reservoir cylinder group (30), wherein the oil reservoir cylinder group (30) comprises a first cavity (321) and a second cavity (322), the oil liquid is stored in the oil reservoir cylinder group (30);
an air cylinder system (40) comprising a first air cylinder group (41) and a second air cylinder group (42), wherein the first air cylinder group (41), the rebound regulating valve and the second cavity (322) are in liquid communication through the second connecting channel, and the second air cylinder group (42), the compression regulating valve and the first cavity (321) are in liquid communication through the third connecting channel.

4. The shock absorber according to claim 3, wherein the oil reservoir cylinder group (30) comprises a first oil reservoir cylinder (31) and a second oil reservoir cylinder (32), the second oil reservoir cylinder (32) is sleeved inside the first oil reservoir cylinder (31), a first gap cavity

(33) and a first oil through channel (34) are formed between the first oil reservoir cylinder (31) and the second oil reservoir cylinder (32), an inner cavity of the second oil reservoir cylinder (32) is formed by the first cavity (321) and the second cavity (322), and the first gap cavity (33) is in liquid communication with the second cavity (322) through the first oil through channel (34);
the first air cylinder group (41) is in liquid communication with the rebound regulating valve through a second oil through channel (13), the rebound regulating valve is in liquid communication with the first gap cavity (33) through a third oil through channel (14), and the second connecting channel is formed by the second oil through channel (13), the third oil through channel (14), the first gap cavity (33) and the first oil through channel (34);
a fourth oil through channel (15) is formed between the first cavity (321) and the compression regulating valve, a fifth oil through channel (16) is formed between the compression regulating valve and the second air cylinder group (42), and the third connecting channel is formed by the fourth oil through channel (15) and the fifth oil through channel (16).

5. The shock absorber according to claim 3, wherein the first air cylinder group (41) and the second air cylinder group (42) are respectively arranged on both sides of the oil reservoir cylinder group (30).

6. The shock absorber according to claim 4, wherein the first oil through channel (34) comprises oil through holes formed in a side wall of the second oil reservoir cylinder (32), and the second oil through channel (13), the third oil through channel (14), the fourth oil through channel (15) and the fifth oil through channel (16) are all formed in the first connecting seat (10).

7. The shock absorber according to claim 4, wherein the oil replenishing system further comprises a piston valve system (50) and a piston rod (60), the piston valve system (50) is assembled at an end of the piston rod (60), another end of the piston rod (60) is assembled to the second connecting seat (20), the piston rod (60) drives the piston valve system (50) to push the oil liquid inside the second oil reservoir cylinder (32) to circulate between the first cavity (321) and the second cavity (322).

8. The shock absorber according to claim 3, wherein the first air cylinder group (41) and the second air cylinder group (42) are both nitrogen cylinders, and a volume of a liquid storage cavity of the first air cylinder group (41) is smaller than a volume of a liquid storage cavity of the second air cylinder group (42).

9. The shock absorber according to claim 8, wherein the first mounting cavity (11), the second mounting cavity (12) and the second air cylinder group (42) are all arranged on a same side of the first connecting seat (10), and the first mounting cavity (11) is arranged between the second mounting cavity (12) and the second air cylinder group (42) along a direction from the first connecting seat (10) to the second connecting seat (20).

10. A vehicle, comprising a frame and the shock absorber according to claim 1, wherein the frame is connected to a first connecting seat (10).

11. The vehicle according to claim 10, wherein the shock absorber further comprises a second connecting seat (20), and another end of the oil replenishing system is connected to the second connecting seat (20).

12. The vehicle according to claim 11, wherein the oil replenishing system comprises:
an oil reservoir cylinder group (30), wherein the oil reservoir cylinder group (30) comprises a first cavity (321) and a second cavity (322), the oil liquid is stored in the oil reservoir cylinder group (30);
an air cylinder system (40) comprising a first air cylinder group (41) and a second air cylinder group (42), wherein the first air cylinder group (41), the rebound regulating valve and the second cavity (322) are in liquid communication through the second connecting channel, and the second air cylinder group (42), the compression regulating valve and the first cavity (321) are in liquid communication through the third connecting channel.

13. The vehicle according to claim 12, wherein the oil reservoir cylinder group (30) comprises a first oil reservoir cylinder (31) and a second oil reservoir cylinder (32), the second oil reservoir cylinder (32) is sleeved inside the first oil reservoir cylinder (31), a first gap cavity (33) and a first oil through channel (34) are formed between the first oil reservoir cylinder (31) and the second oil reservoir cylinder (32), an inner cavity of the second oil reservoir cylinder (32) is formed by the first cavity (321) and the second cavity (322), and the first gap cavity (33) is in liquid communication with the second cavity (322) through the first oil through channel (34);
the first air cylinder group (41) is in liquid communication with the rebound regulating valve through a second oil through channel (13), the rebound regulating valve is in liquid communication with the first gap cavity (33) through a third oil through channel (14), and the second connecting channel is formed by the second oil through channel (13), the third oil through channel (14), the first gap cavity (33) and the first oil through channel (34);
a fourth oil through channel (15) is formed between the first cavity (321) and the compression regulating valve, a fifth oil through channel (16) is formed between the compression regulating valve and the second air cylinder group (42), and the third connecting channel is formed by the fourth oil through channel (15) and the fifth oil through channel (16).

14. The vehicle according to claim 12, wherein the first air cylinder group (41) and the second air cylinder group (42) are respectively arranged on both sides of the oil reservoir cylinder group (30).

15. The vehicle according to claim 13, wherein the first oil through channel (34) comprises oil through holes formed in a side wall of the second oil reservoir cylinder (32), and the second oil through channel (13), the third oil through channel (14), the fourth oil through channel (15) and the fifth oil through channel (16) are all formed in the first connecting seat (10).

16. The vehicle according to claim 13, wherein the oil replenishing system further comprises a piston valve system (50) and a piston rod (60), the piston valve system (50) is assembled at an end of the piston rod (60), another end of the piston rod (60) is assembled to the second connecting seat (20), the piston rod (60) drives the piston valve system (50) to push the oil liquid inside the second oil reservoir cylinder (32) to circulate between the first cavity (321) and the second cavity (322).

17. The vehicle according to claim 12, wherein the first air cylinder group (41) and the second air cylinder group (42) are both nitrogen cylinders, and a volume of a liquid storage cavity of the first air cylinder group (41) is smaller than a volume of a liquid storage cavity of the second air cylinder group (42).

18. The vehicle according to claim 17, wherein the first mounting cavity (11), the second mounting cavity (12) and the second air cylinder group (42) are all arranged on a same side of the first connecting seat (10), and the first mounting cavity (11) is arranged between the second mounting cavity (12) and the second air cylinder group (42) along a direction from the first connecting seat (10) to the second connecting seat (20).
